(19) United States
(12) Patent Application Publication
(10) Pub. No.: US 2023/0207792 A1
(43) Pub. Date: Jun. 29, 2023

(54) NEGATIVE ELECTRODE FOR SECONDARY BATTERY, AND SECONDARY BATTERY

(71) Applicant: MURATA MANUFACTURING CO., LTD., Kyoto (JP)

(72) Inventor: Naoki HAYASHI, Kyoto (JP)

(21) Appl. No.: 18/085,873

(22) Filed: Dec. 21, 2022

(30) Foreign Application Priority Data
Dec. 23, 2021 (JP) 2021-209941

(51) Int. Cl. H01M 4/38; H01M 4/62; H01M 10/0525

(52) U.S. Cl. CPC H01M 4/386; H01M 4/622; H01M 4/625; H01M 10/0525; H01M 2004/027

(57) ABSTRACT

A secondary battery includes a positive electrode, a negative electrode, and an electrolytic solution. The negative electrode includes a negative electrode active material and a negative electrode binder. The negative electrode active material includes a silicon-containing material. Based on an analysis of the negative electrode active material by Raman spectroscopy, a first absorption peak is non-detectable within a range of Raman shift from 1200 cm⁻¹ to 1700 cm⁻¹ both inclusive, and a second absorption peak is detectable within a range of the Raman shift from 400 cm⁻¹ to 530 cm⁻¹ both inclusive. The second absorption peak has a half-width of 30 cm⁻¹ or greater. The negative electrode binder includes a polycarboxylic acid metal salt including a polycarboxylic acid alkali metal salt, a polycarboxylic acid alkaline earth metal salt, or both. The polycarboxylic acid metal salt has a neutralization rate from 10% to 90% both inclusive.

### CROSS-REFERENCE TO RELATED APPLICATIONS

The present application claims priority from Japanese Patent Application No. 2021-209941 filed on Dec. 23, 2021, the entire contents of which are hereby incorporated by reference.

### BACKGROUND

The present application relates to technology relating to a negative electrode for a secondary battery, and a secondary battery.

Various kinds of electronic equipment, including mobile phones, have been widely used.

Such widespread use has promoted development of a secondary battery as a power source that is smaller in size and lighter in weight and allows for a higher energy density.

The secondary battery includes a positive electrode, a negative electrode, and an electrolytic solution. The negative electrode is a negative electrode for a secondary battery. A configuration of the secondary battery has been considered in various ways.

For example, an electrode or an electrode active material layer of a lithium-ion secondary battery includes an active material and a binder which is a polymer compound. The polymer compound includes a carboxyl group, and hydrogen of the carboxyl group is substituted with lithium.

### SUMMARY

A negative electrode for a secondary battery according to an embodiment of the technology of the present application includes a negative electrode active material and a negative electrode binder. The negative electrode active material includes a silicon-containing material.

Based on an analysis of the negative electrode active material by Raman spectroscopy, a first absorption peak is non-detectable within a range of Raman shift that is greater than or equal to 1200 cm⁻¹ and less than or equal to 1700 cm⁻¹, and a second absorption peak is detectable within a range of the Raman shift that is greater than or equal to 400 cm⁻¹ and less than or equal to 530 cm⁻¹. The second absorption peak has a half-width that is greater than or equal to 30 cm⁻¹.

The negative electrode binder includes a polycarboxylic acid metal salt. The polycarboxylic acid metal salt includes a polycarboxylic acid alkali metal salt, a polycarboxylic acid alkaline earth metal salt, or both. The polycarboxylic acid metal salt has a neutralization rate that is greater than or equal to 10% and less than or equal to 90%.

A secondary battery according to an embodiment of the technology includes a positive electrode, a negative electrode, and an electrolytic solution. The negative electrode includes a negative electrode active material and a negative electrode binder. The negative electrode active material includes a silicon-containing material.

Based on an analysis of the negative electrode active material by Raman spectroscopy, a first absorption peak is non-detectable within a range of Raman shift that is greater than or equal to 1200 cm⁻¹ and less than or equal to 1700 cm⁻¹, and a second absorption peak is detectable within a range of the Raman shift that is greater than or equal to 400 cm⁻¹ and less than or equal to 530 cm⁻¹. The second absorption peak has a half-width that is greater than or equal to 30 cm⁻¹. The negative electrode binder includes a polycarboxylic acid metal salt. The polycarboxylic acid metal salt includes a polycarboxylic acid alkali metal salt, a polycarboxylic acid alkaline earth metal salt, or both. The polycarboxylic acid metal salt has a neutralization rate that is greater than or equal to 10% and less than or equal to 90%.

### BRIEF DESCRIPTION OF THE DRAWINGS

The accompanying drawings are included to provide a further understanding of the technology and are incorporated in and constitute a part of this specification. The drawings illustrate example embodiments and, together with the specification, serve to explain the principles of the technology.

FIG. 1 is a sectional view of a configuration of a negative electrode for a secondary battery according to an example embodiment of the technology.

FIG. 2 is a diagram illustrating an example of a result of an analysis of a negative electrode active material by Raman spectroscopy.

FIG. 3 is a perspective view of a configuration of a secondary battery according to an example embodiment of the technology.

FIG. 4 is an enlarged sectional view of a configuration of a battery device illustrated in FIG. 3.

FIG. 5 is a block diagram illustrating a configuration of an application example of the secondary battery.

FIG. 6 is a sectional view of a configuration of a test secondary battery.

### DETAILED DESCRIPTION

Although consideration has been given in various ways to a configuration of a secondary battery, the secondary battery still remains insufficient in a capacity characteristic and a cyclability characteristic. Accordingly, there is still room for improvement in terms thereof.

It is desirable to provide a negative electrode for a secondary battery, and a secondary battery that are each able to achieve a superior capacity characteristic and a superior cyclability characteristic.

In the following, some example embodiments of the technology are described in detail with reference to the accompanying drawings. Note that the following description is directed to illustrative examples of the technology and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments which are not recited in a most-generic independent claim of the technology are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the technology are unillustrated in the drawings.

A description is given first of a negative electrode for a secondary battery according to an example embodiment of the technology. The negative electrode for a secondary battery is hereinafter also simply referred to as a “negative electrode”.

The negative electrode may be used in a secondary battery that is an electrochemical device. However, in an example, the negative electrode may be used in another electrochemical device different from the secondary battery. The other electrochemical device is not particularly limited in kind, and non-limiting examples thereof may include a capacitor.

The negative electrode may allow an electrode reactant to be inserted thereinto and extracted therefrom in an ionic state upon an electrode reaction. The electrode reactant is not particularly limited in kind, and non-limiting examples thereof may include a light metal such as an alkali metal or an alkaline earth metal. Non-limiting examples of the alkali metal may include lithium, sodium, and potassium. Non-limiting examples of the alkaline earth metal may include magnesium and calcium. However, the electrode reactant may be another light metal such as aluminum.

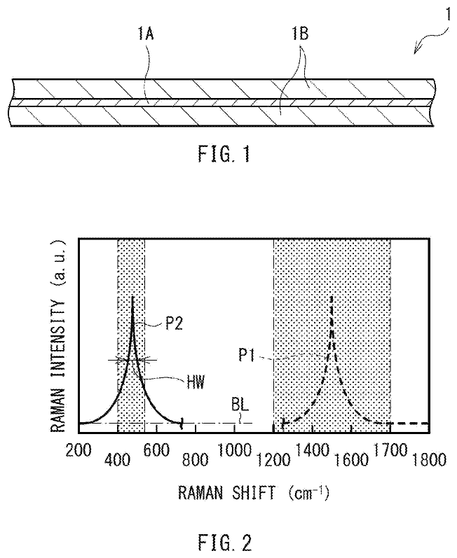

FIG. 1 illustrates a sectional configuration of a negative electrode 1 which is an example of the negative electrode. Note that FIG. 1 illustrates only a portion of the negative electrode 1.

The negative electrode 1 may include a negative electrode current collector 1A and a negative electrode active material layer 1B, as illustrated in FIG. 1.

The negative electrode current collector 1A may have two opposed surfaces on each of which the negative electrode active material layer 1B is to be provided. The negative electrode current collector 1A may include an electrically conductive material such as a metal material. Non-limiting examples of the electrically conductive material may include copper.

In an example embodiment, the negative electrode current collector 1A may have a roughened surface. A reason for this is that adherence of the negative electrode active material layer 1B to the negative electrode current collector 1A may be improved by utilizing a so-called anchor effect. A roughening method is not particularly limited, and may be a method of forming fine particles on a surface of a metal foil by an electrolysis treatment, for example. The electrolysis treatment may be a method of providing asperities on a surface of a metal foil by forming fine particles on the surface of the metal foil by an electrolysis method in an electrolyzer.

The negative electrode active material layer 1B may include a negative electrode active material and a negative electrode binder.

In an example to be described here, the negative electrode active material layer 1B may be provided on each of the two opposed surfaces of the negative electrode current collector 1A. However, in an example, the negative electrode active material layer 1B may be provided on only one of the two opposed surfaces of the negative electrode current collector 1A. For example, in a secondary battery including a positive electrode together with the negative electrode 1, the negative electrode active material layer 1B may be provided on only one of the two opposed surfaces of the negative electrode current collector 1A on a side where the negative electrode 1 is opposed to the positive electrode.

A method of forming the negative electrode active material layer 1B is not particularly limited, and may include, for example, one or more of methods including, without limitation, a coating method, a vapor-phase method, a liquid-phase method, a thermal spraying method, and a firing (sintering) method.

The negative electrode active material may be a material that allows the electrode reactant to be inserted thereinto and extracted therefrom. The negative electrode active material may include one or more of silicon-containing materials. One reason for this is that a high energy density is obtainable owing to superior electrode-reactant insertion capacity and superior electrode-reactant extraction capacity of silicon.

The term “silicon-containing material” may be a generic term for a material including silicon as a constituent element. For example, the silicon-containing material may be a simple substance of silicon, a silicon alloy, a silicon compound, a mixture of two or more thereof, or a material including two or more phases thereof. The silicon-containing material is not particularly limited in state. For example, the silicon-containing material may be a solid solution, a eutectic (a eutectic mixture), or an intermetallic compound, or may include two or more thereof that coexist.

The simple substance of silicon described here may merely refer to a simple substance in a general sense. The simple substance of silicon may therefore include a small amount of impurity, that is, does not necessarily have a purity of 100%.

The silicon alloy is not particularly limited in kind. For example, the silicon alloy may include, as one or more constituent elements other than silicon, one or more of metal elements including, without limitation, tin, nickel, copper, iron, cobalt, manganese, zinc, indium, silver, titanium, germanium, bismuth, antimony, and chromium.

Note that the silicon alloy is not limited to include one or more of the metal elements as the constituent element or constituent elements. For example, the silicon alloy may include one or more of the metal elements and one or more of metalloid elements as constituent elements. The silicon alloy may further include one or more of non-metallic elements as one or more constituent elements.

The silicon compound is not particularly limited in kind. For example, the silicon compound may include, other than silicon, one or more of non-metallic elements including, without limitation, oxygen and carbon as one or more constituent elements. The silicon compound may further include, as one or more constituent elements, one or more of the above-described series of metal elements to be included in the silicon alloy as constituent elements.

Non-limiting examples of the silicon alloy and the silicon compound may include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOₓ (0<x≤2 or 0.2<x<1.4), and LiSiO. Note that a composition of each of the non-limiting examples of the silicon alloy and the silicon compound is not limited to the composition described above and may be modified as desired.

The silicon-containing material is not particularly limited in crystalline state. In an example embodiment, the silicon-containing material may be amorphous. In an example embodiment, a crystalline peak may not be detected around a range of a diffraction angle 2θ from 28° to 29° both inclusive in an analysis of the silicon-containing material by X-ray diffractometry (XRD). A reason for this is that this may suppress formation of a side reaction product which contributes less to the electrode reaction.

For example, the negative electrode active material including the silicon-containing material may have a predetermined physical property to be identified by an analysis of the negative electrode active material by Raman spectroscopy. Details of the physical property of the negative electrode active material will be described later with reference to FIG. 2.

The negative electrode binder may be a material that bonds a material such as the negative electrode active material. The negative electrode binder may include one or more of polycarboxylic acid metal salts. The one or more polycarboxylic acid metal salts included in the negative electrode binder may include a polycarboxylic acid alkali metal salt, a polycarboxylic acid alkaline earth metal salt, or both.

Note that the number of kinds of the polycarboxylic acid alkali metal salts to be included may be only one, or two or more. The number of kinds of the polycarboxylic acid alkaline earth metal salts to be included may also be only one, or two or more.

As will be described later, the negative electrode binder may serve to remove a portion of a high-resistance film provided on a surface of the negative electrode active material including the silicon-containing material, because the negative electrode binder includes the polycarboxylic acid metal salt having a neutralization rate within a predetermined range.

As used herein, the “polycarboxylic acid metal salt” may refer to a metal salt of a polymer compound including multiple carboxyl groups, i.e., a polycarboxylic acid. The polycarboxylic acid is not particularly limited in kind, and may be any polymer compound that includes multiple carboxyl groups.

For example, the “polycarboxylic acid alkali metal salt” may refer to a polymer compound in which some of the carboxyl groups included in the polycarboxylic acid are neutralized with an alkali metal. The “polycarboxylic acid alkaline earth metal salt” may refer to a polymer compound in which some of the carboxyl groups included in the polycarboxylic acid are neutralized with an alkaline earth metal.

For example, in the polycarboxylic acid alkali metal salt, respective hydrogen atoms of some of the multiple carboxyl groups (—COOH) may be substituted with alkali metal atoms. The polycarboxylic acid alkali metal salt may thus include two or more carboxyl groups not subjected to substitution and two or more carboxylic acid alkali metal salt groups subjected to substitution (—COOMA) where MA is an alkali metal element.

In the polycarboxylic acid alkaline earth metal salt, respective hydrogen atoms of some of the multiple carboxyl groups (—COOH) may be substituted with alkaline earth metal atoms. The polycarboxylic acid alkaline earth metal salt may thus include two or more carboxyl groups not subjected to substitution and two or more carboxylic acid alkaline earth metal salt groups subjected to substitution (—COOMB) where MB is an alkaline earth metal element.

The polycarboxylic acid metal salt may therefore have acidity as a whole because only some of the carboxyl groups may be neutralized.

The polycarboxylic acid is not particularly limited in kind, and may be any polymer compound that includes multiple carboxyl groups. Non-limiting examples of the polycarboxylic acid may include a polyacrylic acid, a polyalginic acid, a polymethacrylic acid, and a polymaleic acid.

The alkali metal element is not particularly limited in kind, and non-limiting examples thereof may include lithium, sodium, and potassium. The alkaline earth metal element is not particularly limited in kind, and non-limiting examples thereof may include magnesium and calcium.

Accordingly, non-limiting examples of the polycarboxylic acid alkali metal salt may include lithium polyacrylate, lithium polyalginate, lithium polymethacrylate, lithium polymaleate, sodium polyacrylate, sodium poly alginate, sodium polymethacrylate, sodium polymaleate, potassium polyacrylate, potassium polyalginate, potassium polymethacrylate, and potassium polymaleate. One reason why such a polycarboxylic acid alkali metal salt is used is that the use of the polycarboxylic acid metal salt may facilitate sufficient removal of the high-resistance film.

Non-limiting examples of the polycarboxylic acid alkaline earth metal salt may include magnesium polyacrylate, magnesium polyalginate, magnesium polymethacrylate, magnesium polymaleate, calcium poly acrylate, calcium polyalginate, calcium polymethacrylate, and calcium polymaleate. One reason why such a polycarboxylic acid alkaline earth metal salt is used is that the use of the polycarboxylic acid metal salt may facilitate sufficient removal of the high-resistance film.

The polycarboxylic acid metal salt may be obtained by a process of mixing a neutralization material having alkalinity and a polycarboxylic acid having acidity with each other in a solvent such as an aqueous solvent. In this case, the polycarboxylic acid may be neutralized by the neutralization material, and the polycarboxylic acid metal salt may be obtained as a result.

The neutralization material is not particularly limited in kind, and non-limiting examples thereof may include a hydroxide and a carbonic acid compound. For example, the hydroxide may include one or more of lithium hydroxide, sodium hydroxide, potassium hydroxide, magnesium hydroxide, calcium hydroxide, and other kinds of hydroxides. For example, the carbonic acid compound may include one or more of lithium carbonate, sodium carbonate, potassium carbonate, magnesium carbonate, calcium carbonate, and other kinds of carbonic acid compounds.

In this case, the neutralization rate may be controlled to a desired value by changing a condition such as a mixing amount of the neutralization material.

The neutralization rate (%) of the polycarboxylic acid metal salt is within a range from 10% to 90% both inclusive. The neutralization rate may be calculated on the basis of the following calculation expression: neutralization rate (%)=[number of carboxylic acid metal salt groups/(sum of number of carboxyl groups and number of carboxylic acid metal salt groups)]×100. Note that the “carboxylic acid metal salt group” may include the above-described carboxylic acid alkali metal salt group, the above-described carboxylic acid alkaline earth metal salt group, or both.

A reason why the neutralization rate of the polycarboxylic acid metal salt is within the range from 10% to 90% both inclusive is that the neutralization rate may be made appropriate and the negative electrode binder (the polycarboxylic acid metal salt) therefore has acidity. In this case, a portion of the high-resistance film provided on the surface of the negative electrode active material including the silicon-containing material is removed by using the negative electrode binder having acidity, which improves an electrically conductive property of the surface of the negative electrode active material. This improves an electrically conductive property of the negative electrode active material layer 1B, and therefore improves an electrically conductive property of the negative electrode 1. Accordingly, as will be described later, even if the electrically conductive property of the negative electrode active material is originally low due to the physical property to be identified on the basis of a result of an analysis by Raman spectroscopy, the electrically conductive property of the negative electrode active material improves, and the electrically conductive property of the negative electrode 1 is thus secured.

Note that even in a case of using the negative electrode binder including the polycarboxylic acid metal salt, the negative electrode binder has neutrality if the neutralization rate is 100%. In such a case, the electrically conductive property of the surface of the negative electrode active material including the silicon-containing material decreases because a portion of the high-resistance film is not removable even if the negative electrode binder is used. Accordingly, if the electrically conductive property of the negative electrode active material is originally low due to the physical property to be identified on the basis of the result of the analysis by Raman spectroscopy, it is difficult to secure the electrically conductive property of the negative electrode 1 because of difficulty of achieving improvement in electrically conductive property of the negative electrode active material.

In addition, in a case where the neutralization rate is 0% due to the use of the negative electrode binder including a polycarboxylic acid, a negative electrode conductor is hindered from being dispersed easily in a negative electrode mixture slurry in a process of manufacturing the negative electrode 1 with use of the negative electrode conductor, which will be described later. This decreases the electrically conductive property of the negative electrode active material layer 1B. It is thus difficult to secure the electrically conductive property of the negative electrode 1, as is the above-described case.

A procedure for identifying the neutralization rate of the polycarboxylic acid metal salt may be performed in accordance with a neutralization titration defined by JIS K0070 (test methods for acid value, saponification value, ester value, iodine value, hydroxyl value and unsaponifiable matter of chemical products). For example, 100 ml (=100 cm3) of water and 20 ml (=20 cm3) of a sodium hydroxide standard solution having a concentration of 0.1 M may be added to 1 ml (=1 cm3) of an aqueous dispersion of the polycarboxylic acid metal salt having a concentration of 5 wt %, following which the aqueous dispersion may be stirred and mixed sufficiently. Thereafter, the remaining of the sodium hydroxide included in the aqueous dispersion may be back-titrated with a hydrogen chloride standard solution having a concentration of 0.1 M. A content of the polycarboxylic acid (the carboxyl group) included in the aqueous dispersion may thus be identified to allow identification of the neutralization rate.

Note that, for example, the negative electrode active material layer 1B may further include one or more of other materials.

The other materials may include the negative electrode conductor. The negative electrode conductor may include one or more of electrically conductive materials. A reason for this is that the electrically conductive property of the negative electrode active material layer 1B may improve.

For example, the electrically conductive material may include a carbon material. A reason for this is that the electrically conductive property of the negative electrode active material layer 1B may sufficiently improve.

The carbon material may include a particulate carbon material, a fibrous carbon material, or both. Non-limiting examples of the particulate carbon material may include graphite, carbon black, acetylene black, and Ketjen black. Non-limiting examples of the fibrous carbon material may include a carbon fiber, a carbon nanofiber, and a carbon nanotube. The carbon nanotube may be a single-wall carbon nanotube (SWCNT), a double-wall carbon nanotube (DWCNT), or a multi-wall carbon nanotube (MWCNT).

In an example embodiment, the carbon material may include the fibrous carbon material. In an example embodiment, the carbon material may include the single-wall carbon nanotube. A reason for this is that in such a case, the negative electrode active materials may be electrically coupled to each other via the negative electrode conductor which includes the fibrous carbon material. This improves an electrically conductive network between the negative electrode active materials, which further improves the electrically conductive property of the negative electrode active material layer 1B. An average fiber diameter of the fibrous carbon material is not particularly limited, and may be 5 nm or less, for example. A content of the fibrous carbon material in the negative electrode active material layer 1B is not particularly limited, and may be 0.5 wt % or less, for example.

Note that, for example, the electrically conductive material may be a material other than the carbon material, such as a metal material or an electrically conductive polymer compound. For example, the electrically conductive material may include any two or more of the carbon material, the metal material, or the electrically conductive polymer compound.

In addition, the other materials may include one or more of other negative electrode active materials into which the electrode reactant is insertable and from which the electrode reactant is extractable.

For example, the other electrode active material may include a carbon material, a metal-based material, or both. A reason for this is that a high energy density is obtainable. Note that the silicon-containing material described above is excluded from the metal-based material to be described below.

Non-limiting examples of the carbon material may include graphitizable carbon, non-graphitizable carbon, and graphite. Non-limiting examples of the graphite may include natural graphite and artificial graphite.

The metal-based material may refer to a material including one or more elements among metal elements and metalloid elements that are each able to form an alloy with lithium. Non-limiting examples of such metal elements and metalloid elements may include tin. The metal-based material may be a simple substance, an alloy, a compound, a mixture of two or more thereof, or a material including two or more phases thereof.

In addition, the other materials may include another negative electrode binder. The other negative electrode binder may include one or more of materials including, without limitation, a synthetic rubber and a polymer compound. Non-limiting examples of the synthetic rubber may include a styrene-butadiene-based rubber, a fluorine-based rubber, and ethylene propylene diene. Non-limiting examples of the polymer compound may include polyvinylidene difluoride, polyimide, and carboxymethyl cellulose.

FIG. 2 illustrates an example of a result of an analysis of the negative electrode active material by Raman spectroscopy. In FIG. 2, the horizontal axis represents Raman shift (cm⁻¹), and the vertical axis represents peak intensity (any unit (a.u.)).

The analysis result (Raman spectrum) illustrated in FIG. 2 is obtainable by analyzing the negative electrode active material including the silicon-containing material by Raman spectroscopy. In this case, all of the following three physical property conditions are satisfied, based on the analysis of the negative electrode active material by Raman spectroscopy.

Firstly, a Raman peak P1 (a first absorption peak) is non-detectable within a range of Raman shift that is from 1200 cm⁻¹ to 1700 cm⁻¹ both inclusive. In other words, even if the negative electrode active material including the silicon-containing material is analyzed by Raman spectroscopy, the convex-upward Raman peak P1 having an apex within the range of Raman shift that is from 1200 cm⁻¹ to 1700 cm⁻¹ both inclusive is non-detectable.

In FIG. 2, the Raman peak P1 is indicated by a broken line because the Raman peak P1 is non-detectable, and the range of Raman shift that is from 1200 cm⁻¹ to 1700 cm⁻¹ both inclusive is shaded.

Secondly, a Raman peak P2 (a second absorption peak) is detectable within a range of Raman shift that is from 400 cm⁻¹ to 530 cm⁻¹ both inclusive. In other words, if the negative electrode active material including the silicon-containing material is analyzed by Raman spectroscopy, the convex-upward Raman peak P2 having an apex within the range of Raman shift that is from 400 cm⁻¹ to 530 cm⁻¹ both inclusive is detectable.

In FIG. 2, the Raman peak P2 is indicated by a solid line because the Raman peak P2 is detectable, and the range of Raman shift that is from 400 cm⁻¹ to 530 cm⁻¹ both inclusive is shaded.

Thirdly, the second Raman peak P2 has a half-width HW that is 30 cm⁻¹ or greater. The half-width HW (cm⁻¹) may refer to the full width at half maximum (FWHM). In other words, the half-width HW may be a width of the Raman peak P2 at a level that is half the difference between the minimum value of Raman intensity and the maximum value of Raman intensity, and the width of the Raman peak P2 may be the difference between the maximum value of Raman shift and the minimum value of Raman shift. The difference between the minimum value of Raman intensity and the maximum value of Raman intensity may be calculated as follows: difference between minimum value of Raman intensity and maximum value of Raman intensity=maximum value of Raman intensity−minimum value of Raman intensity. The difference between the maximum value of Raman shift and the minimum value of Raman shift may be calculated as follows: difference between maximum value of Raman shift and minimum value of Raman shift=maximum value of Raman shift−minimum value of Raman shift.

Note that the minimum value of Raman intensity may be determined on the basis of a baseline BL. In a case where the Raman spectrum is substantially flat because the Raman intensity is at the minimum or substantially constant, the baseline BL may be a line segment along the substantially flat portion of the Raman spectrum. The baseline BL may therefore be a line segment extending substantially along the horizontal axis.

A reason why all of the above-described three physical property conditions regarding the physical property of the negative electrode active material including the silicon-containing material, i.e., regarding the result of the analysis of the negative electrode active material by Raman spectroscopy, are satisfied is as follows. That is, a high-resistance film is easily formed on a surface of the silicon-containing material that satisfies all of the three physical property conditions. This causes the electrically conductive property of the silicon-containing material to be originally low. In this case, a portion of the high-resistive film is removable by using the negative electrode binder (the polycarboxylic acid metal salt) having an appropriate neutralization rate. This improve the electrically conductive property of the silicon-containing material, as described above.

For example, the electrically conductive property of the surface of the silicon-containing material is markedly low in a case where the silicon-containing material satisfies the three physical property conditions. In this case, if the negative electrode active material including such a silicon-containing material is used to fabricate the negative electrode 1, the electrically conductive property of the negative electrode active material layer 1B is markedly low. If such a negative electrode 1 is used to fabricate the secondary battery, the characteristic of the fabricated secondary battery is markedly deteriorated accordingly. It is therefore difficult to achieve a high-performance secondary battery.

To address this, the electrically conductive property of the surface of the negative electrode active material layer 1B is improved by using the negative electrode binder (the polycarboxylic acid metal salt) having the appropriate neutralization rate, even if the electrically conductive property of the silicon-containing material satisfying the three physical property conditions is markedly low. In this case, the electrically conductive property of the negative electrode active material layer 1B improves even if the negative electrode active material including the silicon-containing material is used to fabricate the negative electrode 1. Accordingly, if such a negative electrode 1 is used to fabricate the secondary battery, the characteristic of the fabricated secondary battery improves accordingly. It therefore helps to achieve a high-performance secondary battery.

As described above, in a case where the silicon-containing material satisfying the three physical property conditions is used as the negative electrode active material, it is difficult to achieve a high-performance secondary battery due to the originally low electrically conductive property of the silicon-containing material. However, the use of the negative electrode binder (the polycarboxylic acid metal salt) having the appropriate neutralization rate in combination helps to achieve a high-performance secondary battery even if the silicon-containing material satisfying the three physical property conditions is used as the negative electrode active material.

Details of a procedure for analyzing the negative electrode active material by Raman spectroscopy may be as described below.

As an analyzer, for example, a Raman spectrometer RAMAN-11 available from Nanophoton Corporation, located in Osaka, Japan, may be used. Upon the analysis, laser light having a wavelength of 532 nm may be used, a spectrometer of 600 gr/mm may be used, and an analysis range may be so set that the entire negative electrode active material to be analyzed is included within the analysis range.

Note that the half-width HW may be calculated on the basis of the Raman intensity of the Raman peak P2 using the baseline BL as a reference, as described above.

In the negative electrode 1, the electrode reactant may be inserted into the negative electrode active material included in the negative electrode active material layer 1B and the electrode reactant may be extracted from the negative electrode active material upon the electrode reaction. In this case, the electrode reactant may be inserted and extracted in an ionic state.

The negative electrode 1 may be manufactured by a procedure to be described below according to an embodiment.

First, the negative electrode active material including the silicon-containing material and the negative electrode binder including the polycarboxylic acid metal salt may be mixed with each other to thereby obtain a negative electrode mixture. In this case, in an example, another material such as the negative electrode conductor may further be included in the negative electrode mixture.

Thereafter, the negative electrode mixture may be put into a solvent to thereby prepare a negative electrode mixture slurry in a paste form. The solvent may be an aqueous solvent or an organic solvent.

Thereafter, the negative electrode mixture slurry may be applied on the two opposed surfaces of the negative electrode current collector 1A to thereby form the negative electrode active material layers 1B. In this case, in an example, the negative electrode mixture slurry may be heated on an as-needed basis.

Thereafter, the negative electrode active material layers 1B may be compression-molded by means of, for example, a roll pressing machine. In this case, in an example, the negative electrode active material layers 1B may be heated. In an example, the negative electrode active material layers 1B may be compression-molded multiple times.

In this manner, the negative electrode active material layers 1B may be formed on the respective two opposed surfaces of the negative electrode current collector 1A. The negative electrode 1 may thus be completed.

According to the negative electrode 1, the negative electrode 1 includes the negative electrode active material and the negative electrode binder. The negative electrode active material includes the silicon-containing material. The negative electrode binder includes the polycarboxylic acid metal salt. The polycarboxylic acid metal salt includes the polycarboxylic acid alkali metal salt, the polycarboxylic acid alkaline earth metal salt, or both. Regarding the physical property of the negative electrode 1, i.e., the result of the analysis of the negative electrode active material by Raman spectroscopy, the above-described three physical property conditions are satisfied. The above-described three physical property conditions are the following: the Raman peak P1 is non-detectable; the Raman peak P2 is detectable; and the half-width HW is 30 cm⁻¹ or greater. In addition, the polycarboxylic acid metal salt has a neutralization rate within the range from 10% to 90% both inclusive.

In this case, as described above, even if the electrically conductive property of the surface of the negative electrode active material is originally low because of satisfying the three physical property conditions, the electrically conductive property of the surface of the negative electrode active material including the silicon-containing material is improved by using the negative electrode binder (the polycarboxylic acid metal salt) having the appropriate neutralization rate. The secondary battery using the negative electrode 1 therefore helps to achieve a superior capacity characteristic and a superior cyclability characteristic.

In an example embodiment, the polycarboxylic acid metal salt may include one or more of the polyacrylic acid metal salt, the polyalginic acid metal salt, the polymethacrylic acid metal salt, or the polymaleic acid metal salt. This makes it easier to sufficiently remove a portion of the high-resistance film provided on the surface of the negative electrode active material including the silicon-containing material by using the negative electrode binder. The electrically conductive property of the negative electrode 1 therefore further improves. Accordingly, it is possible to achieve higher effects.

In an example embodiment, the negative electrode 1 may further include the negative electrode conductor, and the negative electrode conductor may include a carbon material. This further improves the electrically conductive property of the negative electrode 1. Accordingly, it is possible to achieve higher effects. In this case, in an example embodiment, the negative electrode conductor may include the fibrous carbon material. This further improves the electrically conductive property of the negative electrode 1. Accordingly, it is possible to achieve higher effects.

A description is given next of a secondary battery according to an example embodiment of the technology, the secondary battery including the above-described negative electrode.

The secondary battery to be described here may be a secondary battery that obtains a battery capacity using insertion and extraction of an electrode reactant, and the secondary battery includes a positive electrode, a negative electrode, and an electrolytic solution, as described above.

In the secondary battery, a charge capacity of the negative electrode may be greater than a discharge capacity of the positive electrode. In other words, an electrochemical capacity per unit area of the negative electrode may be set to be greater than an electrochemical capacity per unit area of the positive electrode. This may be to prevent precipitation of the electrode reactant on a surface of the negative electrode during charging of the secondary battery.

Details of the kind of the electrode reactant may be as described above. In the following, described as an example is a case where the electrode reactant is lithium. A secondary battery that obtains a battery capacity using insertion and extraction of lithium is a so-called lithium-ion secondary battery. In the lithium-ion secondary battery, lithium may be inserted and extracted in an ionic state.

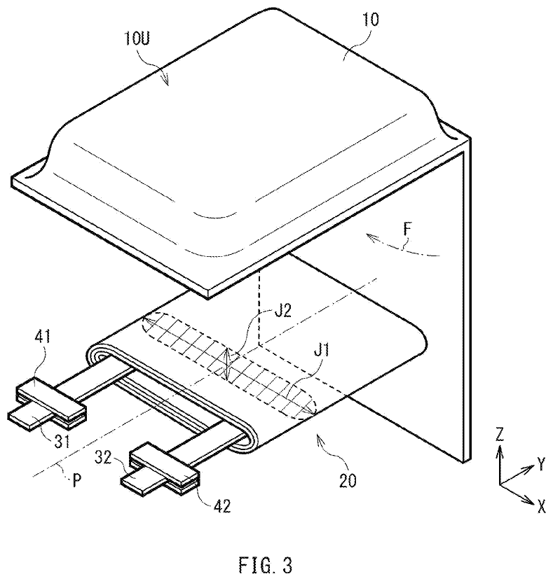

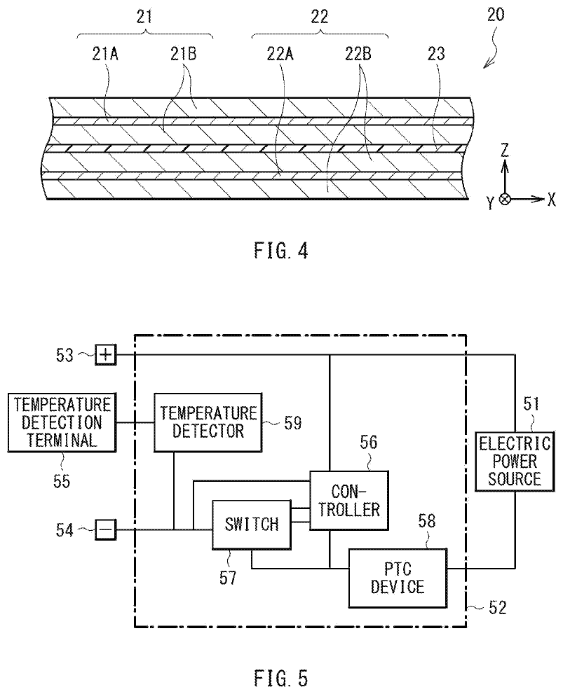

FIG. 3 illustrates a perspective configuration of the secondary battery. FIG. 4 illustrates, in an enlarged manner, a sectional configuration of a battery device 20 illustrated in FIG. 3. Note that FIG. 3 illustrates a state in which an outer package film 10 and the battery device 20 are separated away from each other, and a section of the battery device 20 taken along an XZ plane is indicated by a dashed line. FIG. 4 illustrates only a portion of the battery device 20.

As illustrated in FIGS. 3 and 4, the secondary battery may include the outer package film 10, the battery device 20, a positive electrode lead 31, a negative electrode lead 32, and sealing films 41 and 42. The secondary battery described here may be a secondary battery of a laminated-film type. The secondary battery of the laminated-film type may include the outer package film 10 having flexibility or softness.

As illustrated in FIG. 3, the outer package film 10 may be an outer package member to contain the battery device 20. The outer package film 10 may have a pouch-shaped structure that is sealed in a state where the battery device 20 is contained in the outer package film 10. The outer package film 10 may thus contain a positive electrode 21, a negative electrode 22, and an electrolytic solution that are to be described later.

In the example described here, the outer package film 10 may be a single film-shaped member and may be folded in a folding direction F. The outer package film 10 may have a depression part 10U to place the battery device 20 therein. The depression part 10U may be a so-called deep drawn part.

For example, the outer package film 10 may be a three-layered laminated film including a fusion-bonding layer, a metal layer, and a surface protective layer that are stacked in this order from an inner side. In a state where the outer package film 10 is folded, outer edge parts of the fusion-bonding layer opposed to each other may be fusion-bonded to each other. The fusion-bonding layer may include a polymer compound such as polypropylene. The metal layer may include a metal material such as aluminum. The surface protective layer may include a polymer compound such as nylon.

The outer package film 10 is not particularly limited in configuration or the number of layers. The outer package film 10 may therefore be single-layered or two-layered, or may include four or more layers.

The sealing film 41 may be interposed between the outer package film 10 and the positive electrode lead 31. The sealing film 42 may be interposed between the outer package film 10 and the negative electrode lead 32. Note that in an example, the sealing film 41, the sealing film 42, or both may be omitted.

The sealing film 41 may be a sealing member that prevents entry of, for example, outside air into the outer package film 10. The sealing film 41 may include a polymer compound, such as polyolefin, that has adherence to the positive electrode lead 31. Non-limiting examples of the polyolefin may include polypropylene.

The sealing film 42 may have a configuration similar to that of the sealing film 41, except that the sealing film 42 may be a sealing member that has adherence to the negative electrode lead 32. In other words, the sealing film 42 may include a polymer compound, such as polyolefin, that has adherence to the negative electrode lead 32.

As illustrated in FIGS. 3 and 4, the battery device 20 may be a power generation device that includes the positive electrode 21, the negative electrode 22, a separator 23, and the electrolytic solution. The electrolytic solution is not illustrated. The battery device 20 may be contained inside the outer package film 10.

The battery device 20 may be a so-called wound electrode body. Thus, the positive electrode 21 and the negative electrode 22 may be stacked on each other with the separator 23 interposed therebetween, and may be wound about a winding axis P in a state where the positive electrode 21 and the negative electrode 22 are opposed to each other with the separator 23 interposed therebetween. The winding axis P may be a virtual axis extending in a Y-axis direction.

The battery device 20 is not particularly limited in three-dimensional shape. In this example, the battery device 20 may have an elongated shape. Accordingly, a section of the battery device 20 intersecting the winding axis P, that is, a section of the battery device 20 along the XZ plane, may have an elongated shape defined by a major axis J1 and a minor axis J2. The major axis J1 may be a virtual axis that extends in an X-axis direction and has a larger length than the minor axis J2. The minor axis J2 may be a virtual axis that extends in a Z-axis direction intersecting the X-axis direction and has a smaller length than the major axis J1. In this example, the battery device 20 may have an elongated cylindrical three-dimensional shape. The section of the battery device 20 may thus have an elongated, substantially elliptical shape.

As illustrated in FIG. 4, the positive electrode 21 may include a positive electrode current collector 21A and a positive electrode active material layer 21B.

The positive electrode current collector 21A may have two opposed surfaces on each of which the positive electrode active material layer 21B is to be provided. The positive electrode current collector 21A may include an electrically conductive material such as a metal material. Non-limiting examples of the metal material may include aluminum.

In this example, the positive electrode active material layer 21B may be provided on each of the two opposed surfaces of the positive electrode current collector 21A, and may include one or more of positive electrode active materials into which lithium is insertable and from which lithium is extractable. Note that in an example, the positive electrode active material layer 21B may be provided only on one of the two opposed surfaces of the positive electrode current collector 21A on a side where the positive electrode 21 is opposed to the negative electrode 22. In an example, the positive electrode active material layer 21B may further include one or more of other materials including, without limitation, a positive electrode binder and a positive electrode conductor. A method of forming the positive electrode active material layer 21B is not particularly limited, and may include, for example, one or more of methods including, without limitation, a coating method.

The positive electrode active material is not particularly limited in kind, and non-limiting examples thereof may include a lithium-containing compound. The lithium-containing compound may be a compound including lithium and one or more transition metal elements as constituent elements. The lithium-containing compound may further include one or more of other elements as one or more constituent elements. The other elements may be any elements other than lithium and transition metal elements, and are not particularly limited in kind. Non-limiting examples of the other elements may include elements belonging to groups 2 to 15 in the long period periodic table of elements. The lithium-containing compound is not particularly limited in kind, and may be, for example, an oxide, a phosphoric acid compound, a silicic acid compound, or a boric acid compound.

Non-limiting examples of the oxide may include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Non-limiting examples of the phosphoric acid compound may include LiFePO₄, LiMnPO₄, LiFe_{0.5}Mn_{0.5}PO₄, and LiFe_{0.3}Mn_{0.7}PO₄.

Details of the positive electrode binder may be similar to those of the other negative electrode binders described above. Details of the positive electrode conductor may be similar to those of the negative electrode conductor described above.

The negative electrode 22 may have a configuration similar to that of the negative electrode 1 described above. That is, as illustrated in FIG. 4, the negative electrode 22 may include a negative electrode current collector 22A corresponding to the negative electrode current collector 1A and a negative electrode active material layer 22B corresponding to the negative electrode active material layer 1B.

The separator 23 may be an insulating porous film interposed between the positive electrode 21 and the negative electrode 22 as illustrated in FIG. 4. The separator 23 may prevent contact (a short circuit) between the positive electrode 21 and the negative electrode 22, and may allow lithium ions to pass therethrough. The separator 23 may include a polymer compound such as polyethylene.

The electrolytic solution may be a liquid electrolyte. The positive electrode 21, the negative electrode 22, and the separator 23 may each be impregnated with the electrolytic solution. The electrolytic solution may include a solvent and an electrolyte salt.

In this example, the solvent may include one or more of non-aqueous solvents (organic solvents). An electrolytic solution including the one or more non-aqueous solvents is a so-called non-aqueous electrolytic solution. Non-limiting examples of the non-aqueous solvent may include esters and ethers including, without limitation, a carbonic-acid-ester-based compound, a carboxylic-acid-ester-based compound, and a lactone-based compound. A reason why such a non-aqueous solvent is used is that a dissociation property of the electrolyte salt may improve and ion mobility may also improve.

Non-limiting examples of the carbonic-acid-ester-based compound may include a cyclic carbonic acid ester and a chain carbonic acid ester. Non-limiting examples of the cyclic carbonic acid ester may include ethylene carbonate and propylene carbonate. Non-limiting examples of the chain carbonic acid ester may include dimethyl carbonate, diethyl carbonate, and ethyl methyl carbonate.

Non-limiting examples of the carboxylic-acid-ester-based compound may include a chain carboxylic acid ester. Non-limiting examples of the chain carboxylic acid ester may include ethyl acetate, ethyl propionate, propyl propionate, and ethyl trimethyl acetate.

Non-limiting examples of the lactone-based compound may include a lactone. Non-limiting examples of the lactone may include γ-butyrolactone and γ-valerolactone.

Note that non-limiting examples of the ethers other than the lactone-based compounds may include 1,2-dimethoxyethane, tetrahydrofuran, 1,3-dioxolane, and 1,4-dioxane.

The electrolyte salt may include one or more of light metal salts including, without limitation, a lithium salt. Non-limiting examples of the lithium salt may include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium fluorophosphate (Li₂PFO₃), and lithium difluorophosphate (LiPF₂O₂). One reason such a lithium salt is used is that a high battery capacity is obtainable.

Although not particularly limited, a content of the electrolyte salt may be, for example, within a range from 0.3 mol/kg to 3.0 mol/kg both inclusive with respect to the solvent. A reason for this is that a high ionic conductivity is obtainable.

In an example, the electrolytic solution may further include one or more of additives. The additives are not particularly limited in kind, and non-limiting examples thereof may include an unsaturated cyclic carbonic acid ester, a fluorinated cyclic carbonic acid ester, a sulfonic acid ester, a phosphoric acid ester, an acid anhydride, a nitrile compound, and an isocyanate compound.

Non-limiting examples of the unsaturated cyclic carbonic acid ester may include vinylene carbonate, vinyl ethylene carbonate, and methylene ethylene carbonate. Non-limiting examples of the fluorinated cyclic carbonic acid ester may include fluoroethylene carbonate and difluoroethylene carbonate. Non-limiting examples of the sulfonic acid ester may include propanesultone and propenesultone. Non-limiting examples of the phosphoric acid ester may include trimethyl phosphate and triethyl phosphate. Non-limiting examples of the acid anhydride may include succinic anhydride, 1,2-ethanedisulfonic anhydride, and 2-sulfobenzoic anhydride. Non-limiting examples of the nitrile compound may include succinonitrile. Non-limiting examples of the isocyanate compound may include hexamethylene diisocyanate.

As illustrated in FIGS. 3 and 4, the positive electrode lead 31 may be a positive electrode terminal coupled to the positive electrode current collector 21A of the positive electrode 21, and may be led from an inside to an outside of the outer package film 10. The positive electrode lead 31 may include an electrically conductive material such as a metal material. Non-limiting examples of the electrically conductive material may include aluminum. The positive electrode lead 31 is not particularly limited in shape, and may have any of shapes including, without limitation, a thin plate shape and a meshed shape.

As illustrated in FIGS. 3 and 4, the negative electrode lead 32 may be a negative electrode terminal coupled to the negative electrode current collector 22A of the negative electrode 22, and may be led from the inside to the outside of the outer package film 10. The negative electrode lead 32 may include an electrically conductive material such as a metal material. Non-limiting examples of the electrically conductive material may include copper. Details of a direction in which the negative electrode lead 32 is led may be similar to those of the direction in which the positive electrode lead 31 is led. Details of a shape of the negative electrode lead 32 may be similar to those of the shape of the positive electrode lead 31.

Upon charging the secondary battery, in the battery device 20, lithium may be extracted from the positive electrode 21, and the extracted lithium may be inserted into the negative electrode 22 via the electrolytic solution. Upon discharging the secondary battery, in the battery device 20, lithium may be extracted from the negative electrode 22, and the extracted lithium may be inserted into the positive electrode 21 via the electrolytic solution. Upon the charging and the discharging, lithium may be inserted and extracted in an ionic state.

In a case of manufacturing the secondary battery, according to an example procedure to be described below, the positive electrode 21 and the negative electrode 22 may each be fabricated and the electrolytic solution may be prepared, following which the secondary battery may be assembled using the positive electrode 21, the negative electrode 22, and the electrolytic solution, and the secondary battery may be subjected to a stabilization treatment.

First, a mixture in which the positive electrode active material, the positive electrode binder, and the positive electrode conductor are mixed with each other, i.e., a positive electrode mixture, may be put into a solvent, to thereby prepare a positive electrode mixture slurry in a paste form. The solvent may be an aqueous solvent, or may be an organic solvent. Thereafter, the positive electrode mixture slurry may be applied on the two opposed surfaces of the positive electrode current collector 21A to thereby form the positive electrode active material layers 21B. Thereafter, in an example, the positive electrode active material layers 21B may be compression-molded by means of, for example, a roll pressing machine. In this case, in an example, the positive electrode active material layers 21B may be heated. In an example, the positive electrode active material layers 21B may be compression-molded multiple times. In this manner, the positive electrode active material layers 21B may be formed on the respective two opposed surfaces of the positive electrode current collector 21A. The positive electrode 21 may thus be fabricated.

The negative electrode active material layers 22B may be formed on the respective two opposed surfaces of the negative electrode current collector 22A by a procedure similar to the fabrication procedure of the negative electrode 1 described above. The negative electrode 22 may thus be fabricated.

The electrolyte salt may be put into a solvent. The electrolyte salt may thereby be dispersed or dissolved in the solvent. The electrolytic solution may thus be prepared.

First, the positive electrode lead 31 may be coupled to the positive electrode current collector 21A of the positive electrode 21 by a joining method such as a welding method, and the negative electrode lead 32 may be coupled to the negative electrode current collector 22A of the negative electrode 22 by a joining method such as a welding method.

Thereafter, the positive electrode 21 and the negative electrode 22 may be stacked on each other with the separator 23 interposed therebetween, following which the stack of the positive electrode 21, the negative electrode 22, and the separator 23 may be wound to thereby fabricate an unillustrated wound body. The wound body may have a configuration similar to that of the battery device 20 except that the positive electrode 21, the negative electrode 22, and the separator 23 are each unimpregnated with the electrolytic solution. Thereafter, the wound body may be pressed by means of, for example, a pressing machine to thereby shape the wound body into an elongated shape.

Thereafter, the wound body may be placed inside the depression part 10U, following which the outer package film 10 (fusion-bonding layer/metal layer/surface protective layer) may be folded to thereby cause portions of the outer package film 10 to be opposed to each other. Thereafter, outer edge parts of two sides of the fusion-bonding layer opposed to each other may be bonded to each other by a bonding method such as a thermal-fusion-bonding method to thereby cause the wound body to be contained in the outer package film 10 having a pouch shape.

Thereafter, the electrolytic solution may be injected into the outer package film 10 having the pouch shape, following which outer edge parts of the remaining one side of the fusion-bonding layer may be bonded to each other by a bonding method such as a thermal-fusion-bonding method. In this case, the sealing film 41 may be interposed between the outer package film 10 and the positive electrode lead 31, and the sealing film 42 may be interposed between the outer package film 10 and the negative electrode lead 32.

The wound body may thereby be impregnated with the electrolytic solution. In this manner, the battery device 20 which is the wound electrode body may be fabricated, and the battery device 20 may be sealed in the outer package film 10 having the pouch shape. The secondary battery may thus be assembled.

The secondary battery after being assembled may be charged and discharged. Conditions including, for example, an environment temperature, the number of times of charging and discharging (the number of cycles), and charging and discharging conditions may be set as desired. This process may form a film on a surface of each of the positive electrode 21 and the negative electrode 22. This may bring the secondary battery into an electrochemically stable state. The secondary battery may thus be completed.

According to an embodiment, the secondary battery includes the positive electrode 21, the negative electrode 22, and the electrolytic solution, and the negative electrode 22 may have a configuration similar to that of the negative electrode 1. This helps to achieve a superior capacity characteristic and a superior cyclability characteristic for the above-described reasons.

In an example embodiment, the secondary battery may include a lithium-ion secondary battery. This makes it possible to obtain a sufficient battery capacity stably by using insertion and extraction of lithium. Accordingly, it is possible to achieve higher effects.

Other action and effects related to the secondary battery may be similar to those related to the negative electrode described above.

Next, a description is given of modifications of the above-described secondary battery according to an embodiment.

The configuration of the secondary battery is appropriately modifiable as described below. Note that any two or more of the following series of modifications may be combined with each other.

In the above-described example embodiment, the separator 23 which is a porous film may be used. However, although not illustrated here, in an example embodiment, a separator of a stacked type including a polymer compound layer may be used.

For example, the separator of the stacked type may include a porous film having two opposed surfaces, and a polymer compound layer disposed on one of or each of the two opposed surfaces of the porous film. A reason for this is that adherence of the separator to each of the positive electrode 21 and the negative electrode 22 may improve to suppress the occurrence of irregular winding of the battery device 20. This suppresses swelling of the secondary battery even if the decomposition reaction of the electrolytic solution occurs. The polymer compound layer may include a polymer compound such as polyvinylidene difluoride. A reason for this is that polyvinylidene difluoride may have superior physical strength and may be electrochemically stable.

In an example embodiment, the porous film, the polymer compound layer, or both may include insulating particles. A reason for this is that the insulating particles may facilitate dissipation of heat upon heat generation by the secondary battery, thus improving safety or heat resistance of the secondary battery. The insulating particles may include one or more of materials including, without limitation, an inorganic material and a resin material. Non-limiting examples of the inorganic material may include aluminum oxide, aluminum nitride, boehmite, silicon oxide, titanium oxide, magnesium oxide, and zirconium oxide. Non-limiting examples of the resin material may include acrylic resin and styrene resin.

In a case of fabricating the separator of the stacked type, a precursor solution including the polymer compound and a solvent may be prepared, following which the precursor solution may be applied on one of or each of the two opposed surfaces of the porous film. In this case, in an example, the porous film may be immersed in the precursor solution instead of applying the precursor solution on one of or each of the two opposed surfaces of the porous film. In an example, the insulating particles may be added to the precursor solution.

In the case where the separator of the stacked type is used also, lithium ions are movable between the positive electrode 21 and the negative electrode 22, and similar effects are therefore obtainable. In this case, for example, safety of the secondary battery improves, as described above. Accordingly, it is possible to achieve higher effects.

In the above-described example embodiment, the electrolytic solution which is a liquid electrolyte may be used. However, although not illustrated here, in an example embodiment, an electrolyte layer which is a gel electrolyte may be used.

In the battery device 20 including the electrolyte layer, the positive electrode 21 and the negative electrode 22 may be stacked on each other with the separator 23 and the electrolyte layer interposed therebetween, and the stack of the positive electrode 21, the negative electrode 22, the separator 23, and the electrolyte layer may be wound. The electrolyte layer may be interposed between the positive electrode 21 and the separator 23, and between the negative electrode 22 and the separator 23. Note that the electrolyte layer may be interposed only between the positive electrode 21 and the separator 23, or may be interposed only between the negative electrode 22 and the separator 23.

The electrolyte layer may include a polymer compound together with the electrolytic solution. The electrolytic solution may be held by the polymer compound. A reason for this is that leakage of the electrolytic solution may be prevented. The configuration of the electrolytic solution may be as described above. The polymer compound may include, for example, polyvinylidene difluoride. In a case of forming the electrolyte layer, a precursor solution including the electrolytic solution, the polymer compound, and a solvent may be prepared, following which the precursor solution may be applied on one side or both sides of the positive electrode 21 and on one side or both sides of the negative electrode 22.

In a case where the electrolyte layer is used also, lithium is movable between the positive electrode 21 and the negative electrode 22 via the electrolyte layer, and similar effects are therefore obtainable. In this case, for example, leakage of the electrolytic solution is prevented, as described above. Accordingly, it is possible to achieve higher effects.

Lastly, a description is given of applications (application examples) of the secondary battery.

The applications of the secondary battery are not particularly limited. The secondary battery used as a power source may serve as a main power source or an auxiliary power source, for example, of electronic equipment or an electric vehicle. The main power source may be preferentially used regardless of the presence of any other power source. The auxiliary power source may be used in place of the main power source, or may be switched from the main power source.

Non-limiting examples of the applications of the secondary battery may include: electronic equipment; apparatuses for data storage; electric power tools; battery packs to be mounted, for example, on electronic equipment; medical electronic equipment; electric vehicles; and electric power storage systems. Non-limiting examples of the electronic equipment may include video cameras, digital still cameras, mobile phones, laptop personal computers, headphone stereos, portable radios, and portable information terminals. Non-limiting examples of the apparatuses for data storage may include backup power sources and memory cards. Non-limiting examples of the electric power tools may include electric drills and electric saws. Non-limiting examples of the medical electronic equipment may include pacemakers and hearing aids. Non-limiting examples of the electric vehicles may include electric automobiles including hybrid automobiles. Non-limiting examples of the electric power storage systems may include home battery systems and industrial battery systems for accumulation of electric power for a situation such as emergency. In such applications, one secondary battery may be used, or multiple secondary batteries may be used.

The battery pack may include a single battery, or may include an assembled battery. The electric vehicle may be a vehicle that travels using the secondary battery as a driving power source, and may be a hybrid automobile that is additionally provided with a driving source other than the secondary battery. An electric power storage system for home use may allow electric power accumulated in the secondary battery, which is an electric power storage source, to be utilized for using home appliances.

An application example of the secondary battery will now be described in detail. The configuration of the application example described below is merely an example, and may be appropriately modifiable.

FIG. 5 illustrates a block configuration of a battery pack which is an application example of the secondary battery. The battery pack described here may be a battery pack (a so-called soft pack) including one secondary battery, and may be mounted on, for example, electronic equipment typified by a smartphone.

As illustrated in FIG. 5, the battery pack may include an electric power source 51 and a circuit board 52. The circuit board 52 may be coupled to the electric power source 51, and may include a positive electrode terminal 53, a negative electrode terminal 54, and a temperature detection terminal 55.

The electric power source 51 may include one secondary battery. The secondary battery may have a positive electrode lead coupled to the positive electrode terminal 53 and a negative electrode lead coupled to the negative electrode terminal 54. The electric power source 51 may be coupled to an external power source via the positive electrode terminal 53 and the negative electrode terminal 54, and may thus be chargeable and dischargeable. The circuit board 52 may include a controller 56, a switch 57, a thermosensitive resistive device (a so-called positive temperature coefficient (PTC) device) 58, and a temperature detector 59. However, in an example, the PTC device 58 may be omitted.

The controller 56 may include a central processing unit (CPU) and a memory, and may control an operation of the battery pack. The controller 56 may detect and control a use state of the electric power source 51 on an as-needed basis.

If a voltage of the electric power source 51 (the secondary battery) reaches an overcharge detection voltage or an overdischarge detection voltage, the controller 56 may turn off the switch 57. This may prevent a charging current from flowing into a current path of the electric power source 51. The overcharge detection voltage is not particularly limited, and may be 4.20 V±0.05 V, for example. The overdischarge detection voltage is not particularly limited, and may be 2.40 V±0.10 V, for example.

The switch 57 may include, for example, a charge control switch, a discharge control switch, a charging diode, and a discharging diode. The switch 57 may perform switching between coupling and decoupling between the electric power source 51 and external equipment in accordance with an instruction from the controller 56. The switch 57 may include a metal-oxide-semiconductor field-effect transistor (MOSFET). The charging and discharging currents may be detected on the basis of an ON-resistance of the switch 57.

The temperature detector 59 may include a temperature detection device such as a thermistor. The temperature detector 59 may measure a temperature of the electric power source 51 using the temperature detection terminal 55, and may output a result of the temperature measurement to the controller 56. The result of the temperature measurement obtained by the temperature detector 59 may be used, for example, in a case where the controller 56 performs charge/discharge control upon abnormal heat generation or in a case where the controller 56 performs a correction process in calculating a remaining capacity.

### EXAMPLES

A description is given of Examples of an example embodiment of the technology below.

### Examples 1 to 14 and Comparative Examples 1 to 5

Secondary batteries were fabricated, following which the secondary batteries were each evaluated for a characteristic thereof.

### [Fabrication of Secondary Battery]

The secondary batteries illustrated in FIGS. 3 and 4, i.e., the lithium-ion secondary batteries of the laminated-film type, were fabricated in accordance with the following procedure.

### [Fabrication of Positive Electrode]

First, 95 parts by mass of the positive electrode active material (lithium cobalt oxide (LiCoO₂) which is a lithium-containing compound (oxide)), 3 parts by mass of the positive electrode binder (polyvinylidene difluoride), and 2 parts by mass of the positive electrode conductor (Ketjen black which is amorphous carbon powder) were mixed with each other to thereby obtain a positive electrode mixture. Thereafter, the positive electrode mixture was put into a solvent (N-methyl-2-pyrrolidone which is an organic solvent), following which the solvent was stirred to thereby prepare a positive electrode mixture slurry in a paste form.

Thereafter, the positive electrode mixture slurry was applied on each of the two opposed surfaces of the positive electrode current collector 21A (an aluminum foil having a thickness of 10 μm) by means of a coating apparatus, following which the applied positive electrode mixture slurry was dried to thereby form the positive electrode active material layers 21B.

Lastly, the positive electrode active material layers 21B were compression-molded by means of a roll pressing machine, following which the positive electrode current collector 21A with the positive electrode active material layers 21B formed thereon was cut into a band shape having a width of 70 mm and a length of 800 mm. The positive electrode 21 was thus fabricated.

### [Fabrication of Negative Electrode]

First, 10 parts by mass of the negative electrode active material (the silicon-containing material), 85 parts by mass of the other negative electrode active material (a mesocarbon microbead (MCMB) which is a carbon material), 4 parts by mass of the negative electrode binder (the polycarboxylic acid metal salt), and 1 part by mass of the negative electrode conductor were mixed with each other, to thereby obtain a negative electrode mixture.

As the silicon-containing material, a simple substance of silicon (Si), a silicon-titanium alloy (SiTi_{0.01}) which is a silicon alloy, and silicon oxide (SiO) which is a silicon compound were used. Details of the result of the analysis of the negative electrode active material (the silicon-containing material) by Raman spectroscopy were as listed in Table 1. As the details of the result of the analysis, Table 1 lists: detection or non-detection of the Raman peak P1; detection or non-detection of the Raman peak P2; and the half-width HW (cm⁻¹) of the Raman peak P2.

As the polycarboxylic acid metal salt, the polycarboxylic acid alkali metal salt and the polycarboxylic acid alkaline earth metal salt were used. As the polycarboxylic acid alkali metal salt, lithium polyacrylate (PAALi), sodium polyacrylate (PAANa), potassium polyacrylate (PAAK), lithium polyalginate (PAGLi), lithium polymethacrylate (PMEALi), and lithium polymaleate (PMAALi) were used. As the polycarboxylic acid alkaline earth metal salt, magnesium polyacrylate (PAAMg) and calcium polyacrylate (PAACa) were used. The respective neutralization rates (%) of the polycarboxylic acid metal salts were as listed in Table 1.

In a case of preparing the polycarboxylic acid metal salt, a polycarboxylic acid and a neutralization material were mixed with each other in a solvent (water) to thereby neutralize some of carboxyl groups of the polycarboxylic acid. As the neutralization material, any of lithium hydroxide, sodium hydroxide, potassium hydroxide, magnesium hydroxide, and calcium hydroxide was used depending on the kind of the polycarboxylic acid metal salt. In this case, the neutralization rate was varied by changing a mixing amount of the neutralization material.

As the negative electrode conductor, 0.9 parts by mass of carbon black (CB) which is a particulate carbon material and 0.1 parts by mass of a single-wall carbon nanotube (SWCNT) which is a fibrous carbon material were used in combination. Alternatively, 1 part by mass of carbon black (CB) which is a particulate carbon material was used as the negative electrode conductor.

Thereafter, the negative electrode mixture was put into a solvent (N-methyl-2-pyrrolidone which is an organic solvent), following which the solvent was kneaded and stirred using a planetary centrifugal mixer, to thereby prepare a negative electrode mixture slurry in a paste form.

Thereafter, the negative electrode mixture slurry was applied on each of the two opposed surfaces of the negative electrode current collector 22A (a copper foil having a thickness of 8 μm) by means of a coating apparatus, following which the applied negative electrode mixture slurry was dried with warm air to thereby form the negative electrode active material layers 22B.

Lastly, the negative electrode active material layers 22B were compression-molded by means of a roll pressing machine, following which the negative electrode current collector 22A with the negative electrode active material layers 22B formed thereon was cut into a band shape having a width of 72 mm and a length of 810 mm. The negative electrode 22 was thus fabricated.

For comparison, the negative electrode 22 was fabricated by a similar procedure except that a polycarboxylic acid (a polyacrylic acid (PAA) having a neutralization rate of 0%) was used as the negative electrode binder, as described in Table 2.

### [Preparation of Electrolytic Solution]

The electrolyte salt (lithium hexafluorophosphate (LiPF₆) which is a lithium salt) was added to a solvent (ethylene carbonate which is a cyclic carbonic acid ester and ethyl methyl carbonate which is a chain carbonic acid ester), following which the solvent to which the electrolyte salt was added was stirred. In this case, a mixture ratio (a mass ratio) between ethylene carbonate and ethyl methyl carbonate in the solvent was set to 50:50, and the content of the electrolyte salt with respect to the solvent was set to 1 mol/l (=1 mol/dm³). The electrolytic solution was thus prepared.

### [Assembly of Secondary Battery]

First, the positive electrode lead 31 (an aluminum foil) was welded to the positive electrode current collector 21A of the positive electrode 21, and the negative electrode lead 32 (a copper foil) was welded to the negative electrode current collector 22A of the negative electrode 22.

Thereafter, the positive electrode 21 and the negative electrode 22 were stacked on each other with the separator 23 (a fine-porous polyethylene film having a thickness of 25 μm) interposed therebetween, following which the stack of the positive electrode 21, the negative electrode 22, and the separator 23 was wound to thereby fabricate the wound body. Thereafter, the wound body was pressed by means of a pressing machine to thereby shape the wound body into an elongated shape.

Thereafter, the outer package film 10 was folded in such a manner as to sandwich the wound body placed in the depression part 10U. As the outer package film 10, an aluminum laminated film was used in which the fusion-bonding layer (a polypropylene film having a thickness of 30 μm), the metal layer (an aluminum foil having a thickness of 40 μm), and the surface protective layer (a nylon film having a thickness of 25 μm) were stacked in this order from the inner side. Thereafter, outer edge parts of two sides of the fusion-bonding layer opposed to each other were thermal-fusion-bonded to each other to thereby cause the wound body to be contained in the outer package film 10 having a pouch shape.

Lastly, the electrolytic solution was injected into the outer package film 10 having the pouch shape, following which outer edge parts of the remaining one side of the fusion-bonding layer opposed to each other were thermal-fusion-bonded to each other in a reduced-pressure environment. In this case, the sealing film 41 (a polypropylene film having a thickness of 5 μm) was interposed between the outer package film 10 and the positive electrode lead 31, and the sealing film 42 (a polypropylene film having a thickness of 5 μm) was interposed between the outer package film 10 and the negative electrode lead 32.

The wound body was thereby impregnated with the electrolytic solution. The battery device 20 was thus fabricated. As a result, the battery device 20 was sealed in the outer package film 10, and the secondary battery was assembled.

### [Stabilization of Secondary Battery]

The secondary battery was charged and discharged for one cycle in an ambient temperature environment (at a temperature of 23° C.). Upon the charging, the secondary battery was charged with a constant current of 0.2 C until a voltage reached 4.4 V, and was thereafter charged with a constant voltage of 4.4 V until a current reached 0.025 C. Upon the discharging, the secondary battery was discharged with a constant current of 0.2 C until the voltage reached 3.0 V. Note that 0.2 C is a value of a current that causes a battery capacity (a theoretical capacity) to be completely discharged in 5 hours, and 0.025 C is a value of a current that causes the battery capacity to be completely discharged in 40 hours.

In this manner, a film was formed on the surface of each of the positive electrode 21 and the negative electrode 22. The secondary battery was thereby electrochemically stabilized. As a result, the secondary battery was completed.

### [Design of Capacity Ratio]

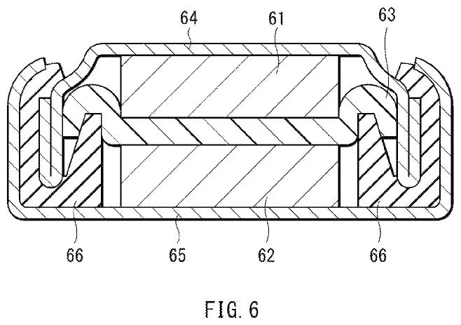

FIG. 6 illustrates a sectional configuration of a test secondary battery of a coin type. In a case of fabricating the secondary battery of the laminated-film type described above, a capacity ratio was designed using the secondary battery of the coin type by the following procedure.

As illustrated in FIG. 6, in the secondary battery of the coin type, a test electrode 61 may be housed in an outer package cup 64 having a bowl-like shape, and a counter electrode 62 may be housed in an outer package can 65 having a bowl-like shape. The test electrode 61 and the counter electrode 62 may be stacked on each other with a separator 63 interposed therebetween. The outer package cup 64 and the outer package can 65 may be crimped to each other by means of a gasket 66. The test electrode 61, the counter electrode 62, and the separator 63 may each be impregnated with an electrolytic solution. The electrolytic solution may have the above-described configuration.

In a case of designing the capacity ratio, first, the positive electrode 21 was fabricated by a similar procedure except that the positive electrode active material layer 21B was formed on only one of the two opposed surfaces of the positive electrode current collector 21A. In addition, the negative electrode 22 was fabricated by a similar procedure except that the negative electrode active material layer 22B was formed on only one of the two opposed surfaces of the negative electrode current collector 22A.

Thereafter, a first secondary battery of the coin type was fabricated using the positive electrode 21 as the test electrode 61 and a lithium metal plate as the counter electrode 62. In addition, a second secondary battery of the coin type was fabricated using the negative electrode 22 as the test electrode 61 and a lithium metal plate as the counter electrode 62.

Thereafter, the first secondary battery was charged to measure an electrical capacity, following which a charge capacity of the positive electrode 21 per thickness of the positive electrode active material layer 21B was calculated on the basis of the measured electrical capacity and the thickness of the positive electrode active material layer 21B. Upon the charging, the first secondary battery was charged with a constant current of 0.1 C until a voltage reached 4.45 V, and was thereafter charged with a constant voltage of 4.45 V until a current was decreased to 1/10 of 0.1 C. Note that 0.1 C is a value of a current that causes the battery capacity to be completely discharged in 10 hours.

Thereafter, the second secondary battery was charged to measure an electrical capacity, following which a charge capacity of the negative electrode 22 per thickness of the negative electrode active material layer 22B was calculated on the basis of the measured electrical capacity and the thickness of the negative electrode active material layer 22B. Upon the charging, the second secondary battery was charged with a constant current of 0.1 C until a voltage reached 0 V, and was thereafter charged with a constant voltage of 0 V until a current was decreased to 1/10 of 0.1 C.

Lastly, the capacity ratio was calculated on the basis of the charge capacity of the positive electrode 21 and the charge capacity of the negative electrode 22. The capacity ratio was calculated on the basis of the following calculation expression: capacity ratio=charge capacity of positive electrode 21/charge capacity of negative electrode 22.

In a case of fabricating the secondary battery of the laminated-film type, a concentration and an application speed of each of the positive electrode mixture slurry and the negative electrode mixture slurry were so adjusted that the capacity ratio became 0.9.

### [Characteristic Evaluation of Secondary Battery]

Evaluation of each of a capacity characteristic and a cyclability characteristic by the following procedure revealed the results presented in Tables 1 and 2.

### [Capacity Characteristic]

In order to evaluate the capacity characteristic in a simple manner, a capacity of the negative electrode 22 (a negative electrode capacity) influencing a battery capacity of the secondary battery was measured instead of measuring the battery capacity of the secondary battery.

In a case of measuring the negative electrode capacity, the secondary battery (the second secondary battery) of the coin type was charged and discharged to thereby measure a discharge capacity, following which a discharge capacity of the negative electrode 22 per thickness of the negative electrode active material layer 22B was calculated on the basis of the measured discharge capacity and the thickness of the negative electrode active material layer 22B.

Upon the charging, the secondary battery was charged with a constant current of 0.1 C until a voltage reached 0 V, and was thereafter charged with a constant voltage of 0 V until a current was decreased to 1/10 of 0.1 C. Upon the discharging, the secondary battery was charged with a constant current of 0.1 C until the voltage reached 1.5 V.

Note that values of the negative electrode capacity listed in each of Tables 1 and 2 are normalized values each obtained with respect to the value of the negative electrode capacity in a case where the polycarboxylic acid metal salt (lithium polyacrylate (PAALi) having a neutralization rate of 100%) was used as the negative electrode binder (Comparative examples 2 and 5) assumed as 100.

### [Cyclability Characteristic]

First, the secondary battery was charged and discharged in an ambient temperature environment (at a temperature of 23° C.), and a discharge capacity (a first-cycle discharge capacity) was measured. Thereafter, the secondary battery was repeatedly charged and discharged in the same environment until the number of cycles reached 100 cycles, and a discharge capacity (a 100th-cycle discharge capacity) was measured. Lastly, a capacity retention rate was calculated on the basis of the following calculation expression: capacity retention rate (%)=(100th-cycle discharge capacity/first-cycle discharge capacity)×100. The capacity retention rate may be an index to evaluate the cyclability characteristic.

Charging and discharging conditions were similar to those in the stabilization of the secondary battery described above except that the current at the time of charging and the current at the time of discharging were each changed to 0.5 C. Note that 0.5 C is a value of a current that causes the battery capacity to be completely discharged in 2 hours.

TABLE 1

| | Negative electrode | | | | Negative electrode | | Negative | Negative | |
|---|---|---|---|---|---|---|---|---|---|
| | active material | | | | binder | | electrode | electrode | Capacity |
| | | Raman | Raman | Half-width | | Neutralization | conductor | capacity | retention |
| | Kind | peak P1 | peak P2 | HW (cm⁻¹) | Kind | rate (%) | Kind | (normalized) | rate (%) |
| Example 1 | SiO | Not detected | Detected | 66 | PAALi | 10 | CB + SWCNT | 110 | 128 |
| Example 2 | SiO | Not detected | Detected | 66 | PAALi | 50 | CB + SWCNT | 115 | 134 |
| Example 3 | SiO | Not detected | Detected | 66 | PAALi | 90 | CB + SWCNT | 104 | 112 |
| Example 4 | SiO | Not detected | Detected | 66 | PAANa | 50 | CB + SWCNT | 113 | 130 |
| Example 5 | SiO | Not detected | Detected | 66 | PAAKa | 50 | CB + SWCNT | 113 | 128 |
| Example 6 | SiO | Not detected | Detected | 66 | PAAMg | 50 | CB + SWCNT | 103 | 113 |
| Example 7 | SiO | Not detected | Detected | 66 | PAACa | 50 | CB + SWCNT | 105 | 112 |
| Example 8 | SiO | Not detected | Detected | 66 | PAGLi | 50 | CB + SWCNT | 110 | 120 |
| Example 9 | SiO | Not detected | Detected | 66 | PMEALi | 50 | CB + SWCNT | 108 | 118 |
| Example 10 | SiO | Not detected | Detected | 66 | PMAALi | 50 | CB + SWCNT | 105 | 123 |
| Example 11 | SiO | Not detected | Detected | 30 | PAALi | 50 | CB + SWCNT | 114 | 124 |
| Example 12 | SiO | Not detected | Detected | 66 | PAALi | 50 | CB | 103 | 105 |
| Example 13 | Si | Not detected | Detected | 35 | PAALi | 50 | CB + SWCNT | 114 | 130 |
| Example 14 | SiTi_{0.01} | Not detected | Detected | 240 | PAALi | 50 | CB + SWCNT | 109 | 123 |

TABLE 2

| | Negative electrode | | | | Negative electrode | | Negative | Negative | |
|---|---|---|---|---|---|---|---|---|---|
| | active material | | | | binder | | electrode | electrode | Capacity |
| | | Raman | Raman | Half-width | | Neutralization | conductor | capacity | retention |
| | Kind | peak P1 | peak P2 | HW (cm⁻¹) | Kind | rate (%) | Kind | (normalized) | rate (%) |
| Comparative | SiO | Not detected | Detected | 66 | PAA | 0 | CB + SWCNT | 99 | 98 |
| example 1 | | | | | | | | | |
| Comparative | SiO | Not detected | Detected | 66 | PAALi | 100 | CB + SWCNT | 100 | 100 |
| example 2 | | | | | | | | | |
| Comparative | SiO | Detected | Detected | 15 | PAA | 0 | CB + SWCNT | 99 | 98 |
| example 3 | | | | | | | | | |
| Comparative | SiO | Detected | Detected | 15 | PAALi | 50 | CB + SWCNT | 100 | 99 |
| example 4 | | | | | | | | | |
| Comparative | SiO | Detected | Detected | 15 | PAALi | 100 | CB + SWCNT | 100 | 100 |
| example 5 | | | | | | | | | |

As described in Tables 1 and 2, the negative electrode capacity and the capacity retention rate each varied greatly depending on the configuration and the physical property of the negative electrode 22.

In the secondary battery using the silicon-containing material as the negative electrode active material, the negative electrode capacity and the capacity retention rate each increased in a case where all of the following five conditions were satisfied (Examples 1 to 14) as compared with a case where not all of the five conditions were satisfied (Comparative examples 1 to 5).
Condition 1: The negative electrode active material included the silicon-containing material.
Condition 2: Based on the analysis of the negative electrode active material by Raman spectroscopy, the Raman peak P1 was not detected and the Raman peak P2 was detected.
Condition 3: The Raman peak P2 had the half-width HW that was greater than or equal to 30 cm⁻¹.
Condition 4: The negative electrode binder included the polycarboxylic acid metal salt (the polycarboxylic acid alkali metal salt or the polycarboxylic acid alkaline earth metal salt).
Condition 5: The polycarboxylic acid metal salt had the neutralization rate within a range from 10% to 90% both inclusive.

In the case where all of the five conditions were satisfied (Examples 1 to 14), if the negative electrode conductor included the fibrous carbon material (Example 2), the negative electrode capacity and the capacity retention rate each further increased as compared with a case where the negative electrode conductor did not include the fibrous carbon material (Example 12).

### Examples 15 to 17 and Comparative Examples 6 to 11

As described in Table 3, the secondary batteries were fabricated by a similar procedure except that the mixture ratio between the two negative electrode active materials (the silicon-containing material (SiO) and the carbon material (MCMB)) was changed, and the secondary battery were each evaluated for a characteristic thereof.

TABLE 3

| | Negative electrode | | | | Negative electrode | | | | |
|---|---|---|---|---|---|---|---|---|---|
| | active material | | | | binder | | Negative | Negative | Capacity |
| | | Mixture | | Mixture | | Neutralization | electrode | electrode | retention |
| | | ratio | | ratio | | rate | conductor | capacity | rate |
| | Kind | (wt %) | Kind | (wt %) | Kind | (%) | Kind | (normalized) | (%) |
| Example 2 | SiO | 10 | MCMB | 85 | PAALi | 50 | CB + SWCNT | 115 | 134 |
| Example 15 | SiO | 20 | MCMB | 75 | PAALi | 50 | CB + SWCNT | 118 | 135 |
| Example 16 | SiO | 30 | MCMB | 65 | PAALi | 50 | CB + SWCNT | 123 | 138 |
| Example 17 | SiO | 90 | MCMB | 5 | PAALi | 50 | CB + SWCNT | 130 | 144 |
| Comparative | SiO | 10 | MCMB | 85 | PAA | 0 | CB + SWCNT | 99 | 98 |
| example 1 | | | | | | | | | |
| Comparative | SiO | 10 | MCMB | 85 | PAALi | 100 | CB + SWCNT | 100 | 100 |
| example 2 | | | | | | | | | |
| Comparative | SiO | 20 | MCMB | 75 | PAA | 0 | CB + SWCNT | 98 | 97 |
| example 6 | | | | | | | | | |
| Comparative | SiO | 20 | MCMB | 75 | PAALi | 100 | CB + SWCNT | 100 | 100 |
| example 7 | | | | | | | | | |
| Comparative | SiO | 30 | MCMB | 65 | PAA | 0 | CB + SWCNT | 96 | 95 |
| example 8 | | | | | | | | | |
| Comparative | SiO | 30 | MCMB | 65 | PAALi | 100 | CB + SWCNT | 100 | 100 |
| example 9 | | | | | | | | | |
| Comparative | SiO | 90 | MCMB | 5 | PAA | 0 | CB + SWCNT | 95 | 94 |
| example 10 | | | | | | | | | |
| Comparative | SiO | 90 | MCMB | 5 | PAALi | 100 | CB + SWCNT | 100 | 100 |
| example 11 | | | | | | | | | |

As described in Table 3, even if the mixture ratio between the two negative electrode active materials was changed, results similar to those described in each of Tables 1 and 2 were obtained. That is, the negative electrode capacity and the capacity retention rate each increased in the case where all of the five conditions were satisfied (Examples 15 to 17) as compared with the case where not all of the five conditions were satisfied (Comparative examples 6 to 11).

Based upon the results presented in Tables 1 to 3, if all of the foregoing five conditions were satisfied regarding the configuration and the physical property of the negative electrode 22, a high negative electrode capacity and a high capacity retention rate were obtained. Accordingly, the secondary battery achieved a superior capacity characteristic and a superior cyclability characteristic.

Although an embodiment of the technology has been described above with reference to some example embodiments and Examples, the configuration of an embodiment of the technology is not limited to those described with reference to the example embodiments and Examples above, and is therefore modifiable in a variety of ways. It should be appreciated that modifications and alterations may be made by persons skilled in the art without departing from the scope as defined by the appended claims. The technology is intended to include such modifications and alterations in so far as they fall within the scope of the appended claims or the equivalents thereof.

For example, although the description has been given of some example embodiments where the battery device has a device structure of a wound type, the device structure of the battery device is not particularly limited, and may thus be of any other type, such as a stacked type or a zigzag folded type. In the stacked type, the positive electrode and the negative electrode may be alternately stacked with the separator interposed therebetween. In the zigzag folded type, the positive electrode and the negative electrode may be opposed to each other with the separator interposed therebetween and be folded in a zigzag manner.

Further, although the description has been given of some example embodiments where the electrode reactant is lithium, the electrode reactant is not particularly limited. In an example embodiment, the electrode reactant may be another alkali metal such as sodium or potassium, or may be an alkaline earth metal such as beryllium, magnesium, or calcium, as described above. In an example embodiment, the electrode reactant may be another light metal such as aluminum.

The effects described herein are mere examples, and effects of an embodiment of the technology are therefore not limited to those described herein. Accordingly, an embodiment of the technology may achieve any other effect.

Furthermore, the technology encompasses any possible combination of some or all of the various embodiments and the modifications described herein and incorporated herein. It is possible to achieve at least the following configurations from the above-described example embodiments of the technology.

(1)

A secondary battery including:

a positive electrode;

a negative electrode including a negative electrode active material and a negative electrode binder; and

an electrolytic solution, in which

the negative electrode active material includes a silicon-containing material,

based on an analysis of the negative electrode active material by Raman spectroscopy, a first absorption peak is non-detectable within a range of Raman shift that is greater than or equal to 1200 wavenumbers and less than or equal to 1700 wavenumbers, and a second absorption peak is detectable within a range of the Raman shift that is greater than or equal to 400 wavenumbers and less than or equal to 530 wavenumbers,

the second absorption peak has a half-width that is greater than or equal to 30 wavenumbers,

the negative electrode binder includes a polycarboxylic acid metal salt,

the polycarboxylic acid metal salt includes a polycarboxylic acid alkali metal salt, a polycarboxylic acid alkaline earth metal salt, or both, and

the polycarboxylic acid metal salt has a neutralization rate that is greater than or equal to 10 percent and less than or equal to 90 percent.

(2)

The secondary battery according to (1), in which the polycarboxylic acid metal salt includes at least one of a polyacrylic acid metal salt, a polyalginic acid metal salt, a polymethacrylic acid metal salt, or a polymaleic acid metal salt.

(3)

The secondary battery according to (1) or (2), in which

the negative electrode further includes a negative electrode conductor, and

the negative electrode conductor includes a fibrous carbon material.

(4)

The secondary battery according to (3), in which the fibrous carbon material includes a single-wall carbon nanotube.

(5)

The secondary battery according to any one of (1) to (4), in which the secondary battery includes a lithium-ion secondary battery.

(6)

A negative electrode for a secondary battery, the negative electrode including:

a negative electrode active material; and

a negative electrode binder, in which

the negative electrode active material includes a silicon-containing material,

based on an analysis of the negative electrode active material by Raman spectroscopy, a first absorption peak is non-detectable within a range of Raman shift that is greater than or equal to 1200 wavenumbers and less than or equal to 1700 wavenumbers, and a second absorption peak is detectable within a range of the Raman shift that is greater than or equal to 400 wavenumbers and less than or equal to 530 wavenumbers,

the second absorption peak has a half-width that is greater than or equal to 30 wavenumbers,

the negative electrode binder includes a polycarboxylic acid metal salt,

the polycarboxylic acid metal salt includes a polycarboxylic acid alkali metal salt, a polycarboxylic acid alkaline earth metal salt, or both, and

the polycarboxylic acid metal salt has a neutralization rate that is greater than or equal to 10 percent and less than or equal to 90 percent.

According to each of a negative electrode for a secondary battery, or a secondary battery according to at least an example embodiment of the technology, the negative electrode for a secondary battery includes a negative electrode active material and a negative electrode binder. The negative electrode active material includes a silicon-containing material. The negative electrode binder includes a polycarboxylic acid metal salt. The polycarboxylic acid metal salt includes a polycarboxylic acid alkali metal salt, a polycarboxylic acid alkaline earth metal salt, or both. Based on an analysis of the negative electrode active material by Raman spectroscopy, a first absorption peak is non-detectable within a range of Raman shift that is greater than or equal to 1200 cm⁻¹ and less than or equal to 1700 cm⁻¹, and a second absorption peak is detectable within a range of the Raman shift that is greater than or equal to 400 cm⁻¹ and less than or equal to 530 cm⁻¹. The second absorption peak has a half-width that is greater than or equal to 30 cm⁻¹. The polycarboxylic acid metal salt has a neutralization rate that is greater than or equal to 10% and less than or equal to 90%. Accordingly, it is possible to achieve a superior capacity characteristic and a superior cyclability characteristic.

Note that effects of an embodiment of the technology are not necessarily limited to those described above and may include any of the series of effects described herein in relation to the example embodiments of the technology.

It should be appreciated that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A secondary battery comprising:
a positive electrode;
a negative electrode including a negative electrode active material and a negative electrode binder; and
an electrolytic solution, wherein
the negative electrode active material includes a silicon-containing material,
based on an analysis of the negative electrode active material by Raman spectroscopy, a first absorption peak is non-detectable within a range of Raman shift that is greater than or equal to 1200 wavenumbers and less than or equal to 1700 wavenumbers, and a second absorption peak is detectable within a range of the Raman shift that is greater than or equal to 400 wavenumbers and less than or equal to 530 wavenumbers,
the second absorption peak has a half-width that is greater than or equal to 30 wavenumbers,
the negative electrode binder includes a polycarboxylic acid metal salt,
the polycarboxylic acid metal salt includes a polycarboxylic acid alkali metal salt, a polycarboxylic acid alkaline earth metal salt, or both, and
the polycarboxylic acid metal salt has a neutralization rate that is greater than or equal to 10 percent and less than or equal to 90 percent.

2. The secondary battery according to claim 1, wherein the polycarboxylic acid metal salt includes at least one of a polyacrylic acid metal salt, a polyalginic acid metal salt, a polymethacrylic acid metal salt, or a polymaleic acid metal salt.

3. The secondary battery according to claim 1, wherein
the negative electrode further includes a negative electrode conductor, and
the negative electrode conductor includes a fibrous carbon material.

4. The secondary battery according to claim 3, wherein the fibrous carbon material includes a single-wall carbon nanotube.

5. The secondary battery according to claim 1, wherein the secondary battery comprises a lithium-ion secondary battery.

6. A negative electrode for a secondary battery, the negative electrode comprising:
a negative electrode active material; and
a negative electrode binder, wherein
the negative electrode active material includes a silicon-containing material,
based on an analysis of the negative electrode active material by Raman spectroscopy, a first absorption peak is non-detectable within a range of Raman shift that is greater than or equal to 1200 wavenumbers and less than or equal to 1700 wavenumbers, and a second absorption peak is detectable within a range of the Raman shift that is greater than or equal to 400 wavenumbers and less than or equal to 530 wavenumbers,
the second absorption peak has a half-width that is greater than or equal to 30 wavenumbers,
the negative electrode binder includes a polycarboxylic acid metal salt,
the polycarboxylic acid metal salt includes a polycarboxylic acid alkali metal salt, a polycarboxylic acid alkaline earth metal salt, or both, and
the polycarboxylic acid metal salt has a neutralization rate that is greater than or equal to 10 percent and less than or equal to 90 percent.
